(19) United States
(12) Patent Application Publication
(10) Pub. No.: US 2006/0129745 A1
(43) Pub. Date: Jun. 15, 2006

(54) Process and appliance for data processing and computer program product

(76) Inventors: Gunther Thiel, Bad Heilbrunn (DE); Mark Hardisty, Surrey (GB)

Correspondence Address: Pauley Petersen & Erickson, Suite 365, 2800 W. Higgins Road, Hoffman Estates, IL, 60195, US

(21) Appl. No.: 11/040,812

(22) Filed: Jan. 21, 2005

(30) Foreign Application Priority Data
Dec. 11, 2004 (DE) 10 2004 059 755.3

(51) Int. Cl. G06F 12/14; G06F 13/28; G06F 12/00; G06F 12/16

(52) U.S. Cl. 711/100

(57) ABSTRACT

The present invention concerns an appliance, a process and a computer program product for the processing of unstructured or semi-structured digital data in a file system. In order to create an appliance, a process and a computer program product which allow simple, reliable, high-performance and purpose oriented management of every manner of digital, stored, unstructured data, it is proposed that, when accessing data, logical access be carried out jointly with physical access and, when doing so, a particularly transparent, common access mechanism be implemented for both types of access.

### FIELD OF THE INVENTION

The present invention concerns a process or a method and an appliance or an apparatus for data processing as well as a corresponding computer program product.

### BACKGROUND OF THE INVENTION

In the age of the information society, it is no longer the creation, processing and distribution of energy but of information which determines the extent of production leading to economic growth; the information factor has become the main resource. Information forms the basis for decisions and human co-operation. At the same time, however, completely new and separate criteria regarding the quality, cost and use of such information are being applied.

Any form of general data which can be stored falls under the heading of information, that is, language, sound and image data in addition to text and numbers in their respective digital data format and storage forms. Thus, the quantity of available data which may also need to be processed in some way is steadily increasing both in a global sense and for each individual user. Whilst increasing CPU power and new architectures render the creation, processing and transport of an ever-increasing volume of data manageable within a reasonable time frame, the long-term, safe administration of digitally-stored data presents a growing problem despite the fact that sufficiently expanded storage space is available. At the same time, it must be possible to permanently ensure that the information contained in the respective digital data packs can be accessed directly by the user at any time and at short notice as and when required.

As a general rule, however, the digital storage of data separates it from its source, its type and its purpose. Today, classification is regularly carried out according to the file names and their extensions with the result that intelligence is still on the side of the application programs when interacting with digital data. These classification specifications are supplemented to a large extent by non-standardized version numbers, dates or other particulars designed to allow the locating and appropriate use of the data.

The problem associated with this can be demonstrated quite simply by means of the self-explanatory example of an old hard disk storage: the data which is stored securely and in an organized fashion in the hard disk stems from programs which, in general, are themselves not contained on the storage device. Now, the successors of the programs which originally created the data, must try to recover the information content of the data by using filters and conversion routines. Every user knows from previous bitter experience that programs have very limited upward and downward compatibility features.

Thus it is the task of the present invention to create a process, an appliance and a computer program product for data processing which allow simple, reliable, high-performance and purpose oriented management of every manner of digitally stored, unstructured data. An appliance or apparatus, according to the present invention, must be capable of being integrated as hardware into all current personal computer and/or data processing environments without basic adjustments having to be made.

### SUMMARY OF THE INVENTION

A method of processing unstructured or semi-structured digital data in a file-based system is characterized by being able to abolish the existing, prior art separation of logical and physical access to data. When data is accessed, therefore, logical access, i.e. with user-defined criteria, is carried out jointly with physical access, i.e. using the file path. In so doing, a common access mechanism is implemented for both types of access which is particularly constructed so as to remain transparent or, in other words, unperceived by the user.

Preferably, a file path is processed within the execution of the access mechanism which has been enhanced by a Query-Interface. In a further development of the present invention, the Query-Interface used in the extended file path constitutes an enhancement of a POSIX- or similar standard in the form of an XQuery-Standard or similar standard.

In a basic embodiment of the invention, arbitrarily pre-definable data subsets are extracted when accessing unstructured and/or proprietary structured data. These extracted data subsets are preferably stored as meta data in a structured form. Thereby intrinsic data subsets, i.e. extracted from the data itself, and/or extrinsic data i.e. derived from outside the data, is used advantageously to create the respective meta data.

By use of a process or a method according to the present invention in an embodiment, meta data is created out of arbitrarily pre-definable data subsets, namely on reading and/or writing or, as the case may be, on storing unstructured and/or proprietary structured data. Thus, any form of access to data is used in order to generate corresponding meta data.

The process is carried out advantageously while preserving the atomicity of the sum of all partial transactions regarding all data which is linked to the respective source data and/or files. In this way, all meta data, which has been derived from inside or outside the data, suffer the same fate as the data itself. Consequently, when deleting the original data, it goes without saying that all logically connected data which was derived from the deleted data by means of a process according to the present invention, is likewise deleted.

In an important, further development of the invention, data is subject to a pre-defined and customizable-rule and action model. In particular, based on the results of the processing of a pre-defined and customizable rule and action model, well-defined decisions and/or actions are carried out. The user is thus given the chance to actively influence the type and choice of rules and actions, for example by modifying the configuration.

According to a particularly advantageous embodiment of the present invention, part-programs or actions of the rule and action model are carried out in the kernel of the operating system, the execution being bound to rules and conditions. The aforementioned partial stages are executed automatically in a further development of the present invention.

According to a further development of the present invention, a process under the present invention is carried out particularly advantageously utilizing standardized software and hardware interfaces. It is hereby executed as an individual unit without interference in or modification to an existing structure, in such a way that mutual interaction can be avoided should retrofitting occur in an existing system. Accordingly, an appliance or apparatus which implements a process under the present invention is characterized by the fact that resources are assigned to connect the appliance to the standardized software and hardware interfaces of the respective data processing installation or the respective system network. A suitable appliance can therefore be integrated as a closed unit into a data processing installation without interference in or modification to an existing structure of the same data processing installation.

In an important further development of the invention, the meta data is set up in its own file system on the basis of the common access mechanism. The file system is optimized for the rapid lookup of data content and/or attributes of data content. In this way, this file system is characterized particularly by allowing a bi-directional, atomic interrelation between data and meta data. This means that, by the same token, modification of the data causes a consistent modification of the affected meta data and vice versa. This allows data and its meta data to be processed independently of one another, thus permitting varying views of the original data stream with respect to format, partial-format, etc.; however, every modification in one view leads to a mandatory modification in all other views. Thus, it makes no difference whether at least one modification is made to the original data stream and/or one of the attributes as a component of the associated meta data, as any modification is likewise reproduced in the other associated part.

Therefore, an appliance in accordance with one embodiment of the present invention involves a method of encompassing all levels of the unstructured data, from its physical representation through logical classification to its information content, the information content being edited and adjusted to fall within a well-defined framework of actions and/or decisions.

A process in accordance with the present invention is advantageously embodied in a computer program product, which means, in particular, in any form of data carrier, for example a CD-ROM. Thus, once imported into the main memory of a data processing installation, this computer program product causes the execution of a process according to one or several of the afore-mentioned criteria.

### BRIEF DESCRIPTION OF THE DRAWINGS

Further advantages and embodiments according to the present invention as well as a corresponding appliance or apparatus, can be described with reference to an implementation example in greater detail by means of the following diagrams:

FIG. 1: a systematic illustration of contemplatable solution areas.

FIG. 2: an illustration of primary methods to answer the question “What does understanding data contents mean”: extractors and converters, extractors being a special form of converters in this case.

FIG. 3: a basic functionality which forms the basis of a process in accordance with the present invention which is named “SmApper.”

FIG. 4: a chart to illustrate the requirement that SmApper must be integrated transparently as an appliance between Storage-Client and Storage-Server.

FIG. 5: a chart as an illustration of stacking as a method which allows the (strictly-speaking) one-dimensional VFS-process to be extended to several dimensions.

FIG. 6: a chart to illustrate how SmApper uses the stacking procedure.

FIG. 7: a diagrammatic representation of how SmApper, as the only meta data solution, spans all layers from the physical representation to the information.

FIGS. 8 and 9: representations of SmApper's fundamental features as a tool to monitor and control unstructured or semi-structured digital packs of data.

### DETAILED DESCRIPTION OF THE PREFERRED EMBODIMENTS

The following will serve as a systematic examination of the chosen approach to the management of unstructured data by means of structured meta data:

1 The Problem

1.1 Starting Point

The resource information has become a decisive factor for production in the age of the information society. According to the study “Data Powers of Ten” [1] we produce new information with a capacity of one to two exabyte per year. This equals about 1,000,000,000,000,000,000 letters, or, in other words, almost all the words that have ever been spoken.

Information is the basis for decision processes and human cooperation, which is one of the main reasons for the importance of digital information as a production factor. This information, however, is completely subject to personal criteria concerning quality, cost and benefit. Today's information and communication (IaC) technologies make information almost universally available without losing any of its individualization, depth or interactivity.

If you know how to use this resource, information, and above all digital information, may be the most important asset of a company. Modern IaC systems make this possible.

Current IaC systems basically comprise three components: data processing, data transmission and data storage according to Gartner, IDC and Forrester information technology (IT) departments already spend more than 50 percent of their hardware investments on data storage systems.

Data storage systems have been optimized to store data and make it available. From a technical point of view the nature of data is insignificant. Radiographs, family pictures, emails, letters of financial data are all treated the same way. Intelligent handling of digital data today is still based on the application, i.e. the many specialized programs and software such as SAP, Microsoft Word, Adobe Photoshop, etc.

The majority of today's digital information is rich media data, with content such as pictures, video, sound, graphics or other non-text based information. It is only meta data that makes them available for processing and commercial use. Examples of such meta data is contract and legal information, serial numbers, forms or comments that are needed for administration, easy location of the data and its appropriate usage.

At present the administration and usage of the relevant meta data and the original data are completely isolated from each other. There is no consistent standard to regulate how meta data and data can be stored and administered together. Meta data is stored in the same way as the original data as the storage infrastructure does not recognize any difference. However, meta data is usually more important for the cooperation than the original data.

Thus it is almost impossible to administer, let alone find, unstructured data that cannot be saved into a database, e.g. addresses.

Various solutions to deal with this problem do exist, but they either deal with a restricted type of data, are proprietary and expensive or optimized for a very specific use. In most cases there is simply no all-encompassing solution available today.

1.2 Solution Areas—The System

The simple and purpose oriented management of digital data is one of the biggest challenges currently faced. To solve this problem you have to examine the specific interests and needs of each of the following groups:
Users
Business management
IT specialists/systems
IT industry

The user's point of view:

Simple, fast, direct—users want to find and read the information that is relevant to them without paying too much attention to the details of the technical solution. They don't want to be overwhelmed by an endless flow of information, but they want exactly the data they need for processing and that is relevant to their specific work area. If you have no CAD software installed you have no use for an Autocad file. Furthermore, data must be up-to-date. We all know the problem faced when trying to retrieve a word document that has been saved under various names (abc_{—}1.doc, abc_{—}2.doc 2_abc.doc etc.) but without any indication of the latest version.

The business point of view:

The core issue concerning digital cooperation for a company is: how do we make sure that the right data of the right quantity and quality are in the right place at the right time? Data has to be transferred between a company's organizational units based on business related rules. This process specific approach has to be independent of the underlying IT infrastructure (and especially the storage infrastructure).

The IT point of view:

The “Information Lifecycle Management (ILM)” describes the main requirements of IT systems. Data has to be made available according to its functional use and relative importance. It is essential to understand the workflow between single departments and units concerning data exchange and the quality requirements for data storage (availability, speed of access, quality data such as image resolution, etc.). Also, all these requirements should be reconciled with the total cost of ownership (TCO) of data management (i.e., what costs incur to provide data of the category x).

For example: A company has to store financial data for several years due to legal requirements. However, you do not expect that every single subsidiary needs high speed access to this data at any given time. Storing this data on tapes, CD-ROMS and the like is a totally adequate method of archiving it.

A new way of object and data oriented data management can only be successful if such tools or systems can be smoothly integrated into the existing infrastructure.

The IT industry's point of view:

Today the success of new products or new technologies are based on the coordination with big software producers or independent software vendors (ISVs), such as SAP, Oracle, etc., and system integrators, Accenture, CGEY, Bearing Point, etc., who recommend the appropriate IT infrastructure needed to solve business problems. Intelligent data management can be detached from the application itself thus resulting in leaner applications with a better cost-effective development process. Data management usually is no longer the core competence of ISVs, so new features based on this might now be realized while they had to be cut before due to the high costs. From the system integrator's point of view rule based data management especially with regard to the Information Lifecycle Management can offer big potentials for professional services. In such a data management scenario system integrators also attach great importance to the idea of infrastructure consolidation concepts and an improved projection of business processes on IT processes.

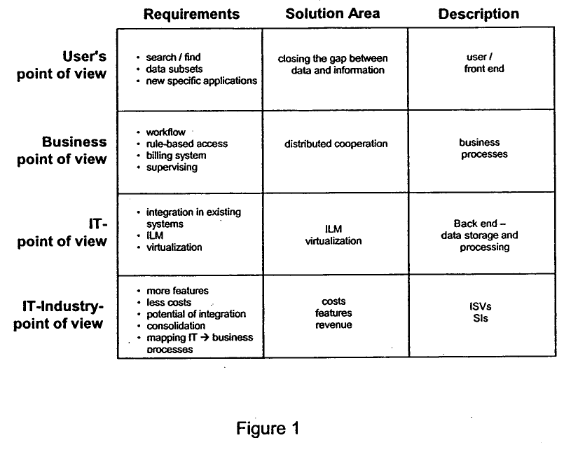

The solution system can be summarized in the diagram of FIG. 1.

If you look at how these requirements are met today you will find an overlapping of various markets and solution approaches. There are different solutions from the point of view of manufacturers of infrastructure components (above all data storage systems, operation systems and file systems, databases) and manufacturers of applications and user software (Content Management Systems (CMS), file management systems (FMS), Information Lifecycle Management Systems (ILM) or Backup/Recovery Tools and Workflow and Collaboration Systems).

The diagram of FIG. 1 describes the overlapping of the different solution approaches.

2. The Solution

2.1 Brief Definition of the Solution

In order to create a system that integrates all approaches mentioned above and makes them compliant with the heterogeneous requirements, we assume that in principle the following solution is needed:
Ubiquitous data access must be possible.
The system must be able to understand the contents of the data and manage it accordingly; it must be possible to create meta data.
Rules must be set to manage data on the basis of business processes.
The solution must fit perfectly into the existing infrastructure, it must be scalable and expandable.

The system shall allow data management of the next generation, namely at the location where the data are stored. Thus the solution must represent a transparent expansion of the storage infrastructure and not be just another business application, e.g. Enterprise Content Management Systems.

The key component of the solution is a layer that allows business rules to be defined and to directly and easily map not only data and meta data, but also their management, storage location, life cycle and flow.

2.2 Detailed Requirements

In order to fulfill all the requirements for digital data management discussed here, the following basic solution requirements (afterwards also called system) must be reconciled irrespective of the manner of implementation:

Administration of Data and Meta Data
The system is designed for unstructured data, that is, for the administration of files (and not for databases, records and so on)
Data and its meta data must be treated as a single unit
It must be possible to separate the access, administration and modification of data and meta data
Each modification of the data must be reflected in the meta data and vice versa where feasible and appropriate
It must be possible to create meta data automatically from the source data
It must be possible to create meta data manually (by interaction with the user)
It must be possible to define which meta data should be created from the source data
The system must be able to ‘learn’ new datatypes at any time
It must be possible to integrate external datatype-modules from other datatype specialists into the system (in compliance with pre-determined syntax and semantics) without compromising the quality of the whole system
The system must allow datatype conversion and abstraction
It must be possible to retrieve meta data, or a definable excerpt from the meta data, via a ‘Query-Language’
Meta data, or a definable excerpt from the meta data, must be capable of being exported automatically into non-system environments (like billing applications, SAP-Systems, etc.)
It must be possible to provide several versions of the same data—each version clearly distinguishable from another—and to be able to assign accurately the relative modifications of this data and meta data, with respect to content, origin and time.

Smooth Integration into Existing Environments
It must be possible to store data in the usual fashion without mandatory modifications to the client and/or server
The system must not impair existing security standards
The system must be scalable in such a way that no existing Service Level Agreements (SLAs) are lost or forfeit
It must be possible to continue to use existing data storage systems, networks and other infrastructure components
It must be possible to integrate new technologies, in theory at least, particularly with regard to storage aspects
Access to data and meta data must be possible regardless of location within the framework of the given infrastructure

Virtualization
Rules must be able to describe which data should be stored physically at which location and how often
This physical storage location must be allowed to change even during the life cycle of the data, contingent upon definable rules
The physical storage location must remain discernable for access

3. Solution Design

3.1 Concept of the Base Types

One aspect of the invention, herein referred to as “SmApper,” focuses on file-based data. More particularly, the invention may be used in a data processing system of managing unstructured or semi-structured digital data in a file system supported by a computer, the computer having a memory. At this point, the construction base_type is introduced as a simpler abstraction of the term file. A base_type is most easily comprehended by borrowing from the object-oriented design approach. According to this model, a base_type is a class with well-defined properties (designated as attributes in the following sections) and methods. A base_type is nothing more than the logical encapsulation of any file (in theory).

Thus, a base_type has as its primary attribute the binary representation of the data contained in the respective file. Further attributes are, for example, date fields, which indicate when the data was last accessed or modified and so on. The methods provided by a base_type include, in particular, the capability to access this binary data, to modify it and render the respective condition of the data persistent (in the file). A base_type is a logical construction, which is not made persistent in itself but is merely a medium of describing a physical file and the methods which can be applied to it. At this point it should be noted that the distinction between a file, which is itself only a logical construction of a file system (in order to classify the actual physical blocks on the respective secondary storage system), and the actual physical data characteristics (of the blocks) has been waived in the following sections.

A base_type and its methods and properties depend, therefore, on the respective file to which this construction is applied but also, of course, on the capabilities of the fundamental file system. The actual instantiation of a base_type results in an object with an allocated file. The following will serve as an illustration of the base_type using C++ class (which is however not fully implemented):

public class base_type {

public:

// con/destruction
base_type(const char * filename);
^{˜}base_type( );
//methods
ssize_t read(...)
ssize_t write(...)
ssize_t lseek(...)
etc.

private:

// pointer to opaque data stream
void *m_data;
// where is my physical file
const char *m_path;
// Filedescriptor
int fd;

}

One of the basic requirements of the system is that it considers data and meta data as a single unit. For this reason, a new data type is introduced on the basis of the base_type known as the smap_base_type. The smap_base_type is an extension of any base_type and can be best described using the term inheritance. A smap_base_type is derived from a base_type and then adds extra methods and attributes. Thus a new, autonomous, encapsulated data type is created, which represents the foundation for all further discussion in the following sections. Each SmapType has a number of attributes <0, n>. For example ‘pages’ which could be the number of pages in an MS-Word document.

Attributes may have base_type-intrinsic values; abstracted from the base_type or extrinsic; freely-defined values. Every attribute has an explicit qualifier or unique identifier (UID) and is classified by a data type. This could be either simple data types (like int, char, etc.) or complex data types (like string, smap_base_type, etc.). Each attribute possesses a value that corresponds to the data type as well as additional parameters which describe further properties of the attribute. One example of the use of such a parameter is scope=system, which indicates that the attribute is a system attribute that may be read only and not modified by the user. Moreover, attributes can be constructed hierarchically (e.g. there could be a subtitle in a document which forms a child-relationship to a title-attribute).

A smap_base_type offers methods for reading, setting, numbering or iterating values.

3.2 Extractors and Converters

As one of its core requirements, SmApper needs to be able to understand data in form and content in order to allow customizable decisions on the basis of this information. What does it mean to understand data in form and content? Well this will vary from one case to another. In one application context ‘comprehension’ may simply entail extracting the number of pages of a Word document from its binary representation. In another context it may be necessary to extract the titles of the individual chapters.

In a more general sense, data comprehension can be defined as follows:

1. Two methods are applied to the binary stream:
data is extracted
optional: specific function is applied to the extracted data (=convert)

2. The new data set thus created must conform to a well-known data type to which well-defined operations can be applied.

3. This data set must be associated with a context.

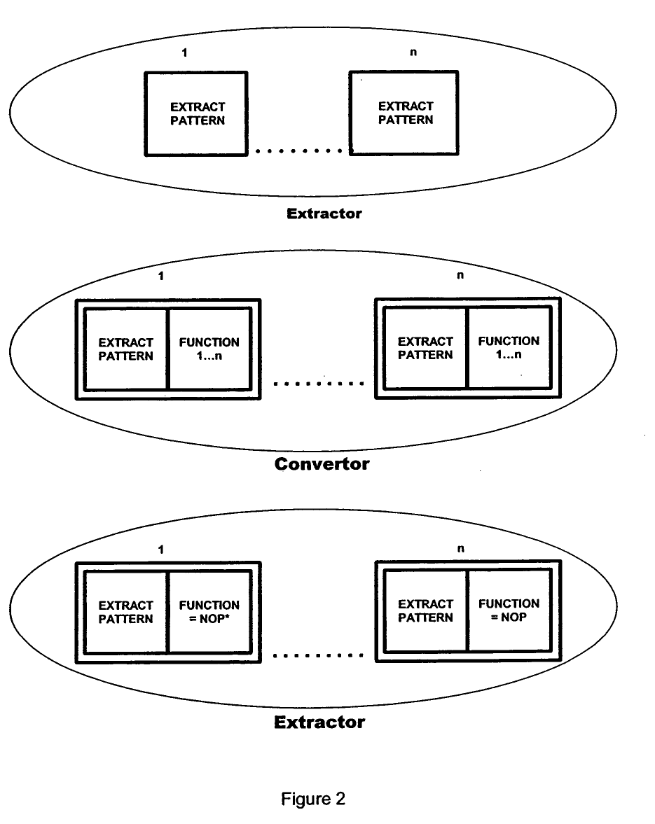

FIG. 2 shows a diagrammatic representation of both methods: the Extractor and the Converter. As demonstrated in the diagram, an extractor is a set of extract patterns which determine how much of which data is to be extracted to which location within a binary stream. A converter, on the other hand, extracts data and then applies a function on it. On closer examination of this diagram we see that an extractor is a special form of a converter, and is in fact a converter with a null-function per pattern. Thus, extractors are a special form of converters.

With the assistance of the base types constructions and the above-mentioned converters and extractors, we are now capable of examining in greater detail the basic functions that SmApper offers in the next section.

3.3. SmApper—Basic Functions

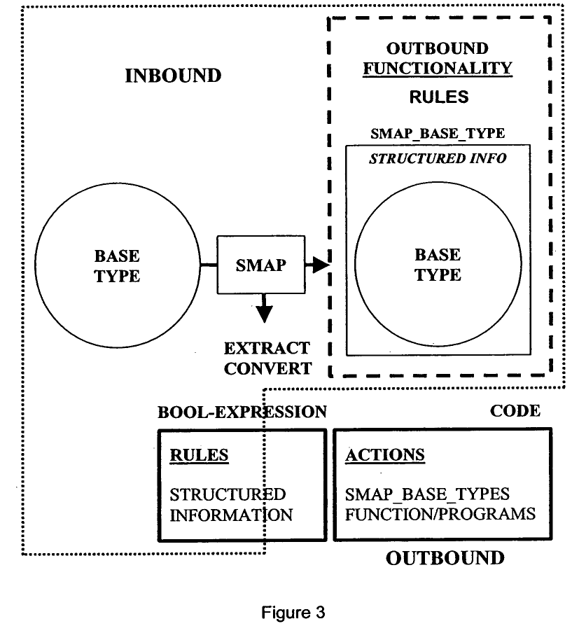

FIG. 3 demonstrates the basic functions that SmApper provides. These basics, which will be examined in depth in the following sections, form the SmApper core system, with the aid of which the actual modules (or applications) can then be developed. The main tasks of the SmApper System are as follows:

1. To generate a smap_base_type out of a base_type by means of converters and extractors.

2. Access to the smap_base_type (the actual file and the attributes)

3. Additional functions on the basis of smap_base_types (rules, actions)

When extractors and converters are applied, the data subsets generated are assigned to attributes of the smap_base_types and hence are brought into the correct (that is to say definable) context. The manner in which the smap_base_type manages its attributes guarantees the data integrity of the individual attributes. Or, to put this a different way, this means that SmApper appends structured data to unstructured data.

Access to the attributes of a smap_base_type must be possible by direct means and must, in addition, permit a Query-Interface in order to locate attribute contents.

Rules enable the forming of Boolean Expressions on these attributes by means of attributes and permitted operators which show ‘True’ or ‘False’ as a result. Rules access solely the structured information of the smap_base_type thereby offering the possibility to reach a decision based on the data. According to FIG. 3, rules run inbound as well as outbound. Inbound means that the affected system component runs in the kernel space of the SmApper (basic) operating system while outbound means that the scope of the code segment is user space. Please see Section 4.1 for further information.

In turn, actions enable programs to be executed on the basis of events and conditions (rules), in order to initiate corresponding operations.

Together, rules and actions form the crucial unit enabling decisions to be reached and actions to be carried out on the basis of available data. The fundamental lemma, on which SmApper is based and which, in addition, permits a distinction to other implementations of related problems, reads as follows:

SmApper guarantees the complete integrity of the smap_base_type. As soon as any modification to the base_type is made, SmApper displays this automatically for the user and/or the application program atomically in the smap_base_type. In the same way, any (permitted!) modifications to the smap_base_type or its attributes are automatically as well as atomically displayed in the base_type.

Network File I/O and Appliance

It is one of SmApper's basic requirements (see Section 2.1) that it must be able to integrate itself smoothly into existing infrastructures. Moreover, SmApper restricts itself to unstructured data, meaning file data. In addition, it must be possible to access the data from any point in the network at any time. These requirements make it absolutely essential to apply one of the basic requirements to the implementation as follows (particularly while taking the detailed requirements into account, see Section 2.2):
SmApper focuses on the Network File I/O
SmApper must be integrated smoothly into the Network File I/O communication (CIFS, NFS, DAFS, WebDav)
This is only possible without modifying the Client/Server and Storage Infrastructure by installing a Black Box (appliance) that is integrated “invisibly” into the data traffic between Storage-Client and Storage-Server

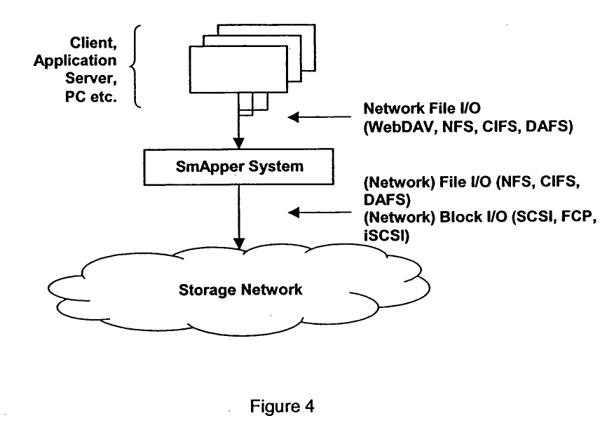

The diagram of FIG. 4 shows these basic requirements of SmApper

4. SmApper—the Implementation

SmApper must be able to handle every Network File I/O protocol for Storage-Clients and for Storage-Servers even every storage protocol (file and block) must be handled. In addition, SmApper must have the ability to switch into the communication between Storage-Client and Storage-Server, in order to implement its additional functions smoothly. The only technical alternative which permits such a procedure without re-inventing the wheel each time and without having to integrate itself into every imaginable protocol stack, is known as stacking [2,3,5].

4.1. Stacking and VFS

Before we can explain the meaning of the term stacking, it is necessary to define the meaning of VFS. VFS stands for Virtual File System and stands for a layer, which has become a standard part of modem operating systems and which enables the homogenization of access to heterogeneous physical file system implementations. VFS is a term from the Linux kernel which may be known by a different name in other operating systems and which, by its nature, is implemented differently, for example the VNODE-layer under SOLARIS; however, the purpose of this layer is always the same. When we talk about VFS in the following paragraphs, we mean the underlying concept and not the Linux-specific implementation.

A modern operating system must support a wide array of different file systems: local file systems like NTFS, UFS, XFS, ReiserFS, VxFS, ext2/3, FAT, CD-ROM file systems, to name but a few. In addition, there are network file systems like NFS, CIFS, DAFS, coda and others.

In order that an application does not have to control the different implementations of the individual file systems, the operating system core (kernel) abstracts the underlying physical implementations with the help of the VFS-Layer and compels the physical FS-implementations to abide by a set of pre-defined functions, which may be optionally implemented to some degree. The VFS-Layer then ensures that each implementation of the necessary function(s) of the physical file system is retrieved when accessed [6, 7, 2]. Although the individual kernel implementations were not developed with the help of object-oriented language tools, on closer examination this concept is about Function Overloading which can be easily demonstrated therefore by virtual functions. Thus, the VFS-Layer makes a set of virtual functions available, which (can) then be overwritten by the real implementations.

Stacking constitutes a process that avails itself of the VFS concept intensively and, in doing so, extends the process. A conventional VFS implementation primarily allows for a VFS-Layer that can retrieve N file systems. Stacking, however, facilitates the retraction of the M VFS-layers as a matter of principle, in which the VFS-layer at position M retrieves the VFS-layer at position M-1 and so on until the actual physical implementation of the underlying file system(s) is retrieved [4].

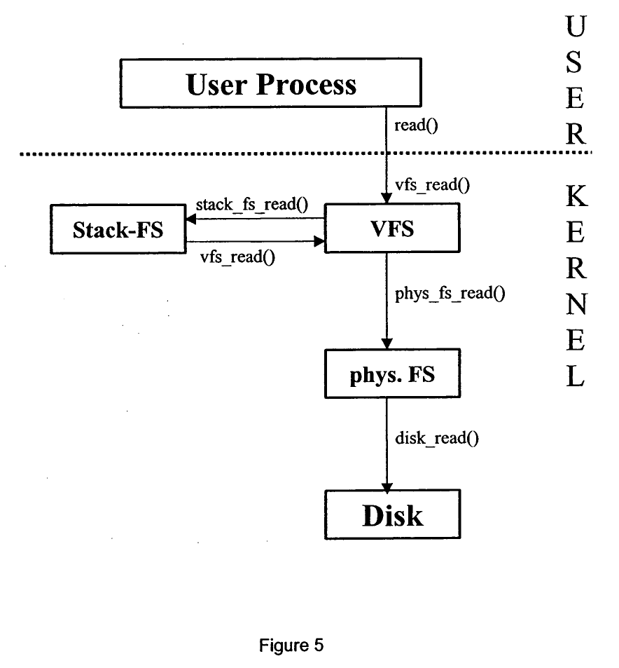

FIG. 5 illustrates this process, showing that stacking is a method which allows the expansion of the primarily one-dimensional VFS process into a multi-dimensional one [4].

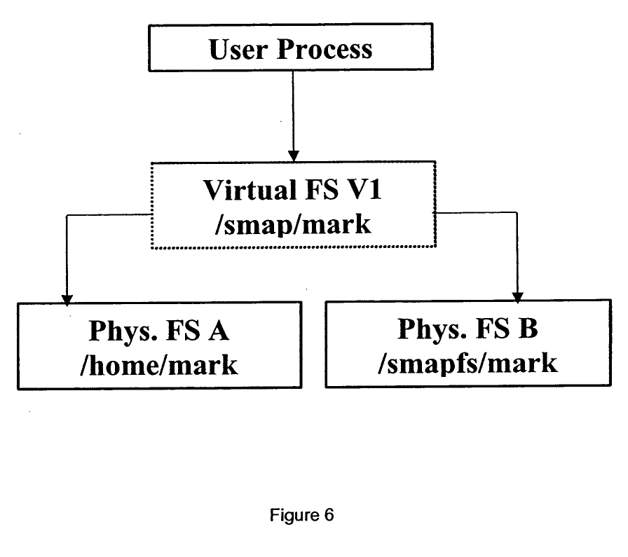

A tangible alternative to the stacking concept is the one that SmApper applies in order to control the problem of smooth integration in the communication paths between user-defined Storage-Clients and Storage-Servers. As FIG. 6 shows, SmApper applies the stacking process in order to provide the user/application program with a virtual file system (which the user perceives as an actual physical file system). This virtual file system masks two (in principle n) actual physical file systems, namely Phys. FS A which, in our illustration, constitutes the actual path and storage-server the user wishes to access. Phys. FS B of FIG. 6 denotes the so-called QZone (see Section 4.2 entitled QZone and Caching) of a SMAP_FS (see Section 4.3 entitled SMAP_FS) where the smap_base_type for every relevant file retrieved by Phys. FS A is represented in terms of functionality, as demonstrated in Section 3.3.

4.2 QZone and Caching

One of the essential basic functions of SmApper is the ability to generate data subsets out of the original data stream with the help of the illustrated extractors and make them persistent as smap_base_type-attributes using the SMAP_FS. SmApper makes it possible to execute the extraction completely inbound (that is, while the data stream is being generated or modified and so on) or outbound. The latter is particularly important as there are certain extraction procedures which require too much time to be executed inbound. In this case, or if specified by the user, the data extraction must be effected once the I/O operation has been completed, i.e. in an asynchronous manner.

According to FIG. 6 SmApper applies the stacking process in order to combine all user-defined Phys. FS As with all Phys. FS Bs (QZone of a SMAP_FS) thus guaranteeing the persistent connection between a base_type and a smap_base_type.

As the extracted data could lead, in connection with rules and actions (see the section on rules and actions), among other things, to the physical storage location, the mode of storage of the original data, the security attributes, etc. being modified, the original file must be buffered in the meantime. SmApper provides the so-called QZone (quarantine zone) for this purpose; this constitutes a physical location which meets all requirements (availability, etc.) and offers, preferably, a high-performance file system.

The QZone is not only essential in order to permit outbound-smapping but offers further advantages, as it can be regarded as a caching-entity. To wit, SmApper has its own QZone-daemon which determines the specific time that the actual physical displacement of the buffered data to its designated destination (target-destination, as defined by the user at the original I/O) should take place. The parameters for this decision can be as diversified as with any other I/O operation on a SmApper system. Moreover, it is of course possible to displace the data to any other physical location, as the SMAP_FS can restore the, connection to the original path at any time. An example of such a purposely delayed displacement out of the QZone would arise if the QZone were accommodated on a Nearline-Storage-System where files could remain until a proportionately high frequency of access requests would make a displacement/copying to one or more other locations expedient. Ideally, such a situation would arise within a concept like the storage grid from Network Appliance, leading to a simplified Information Lifecycle Management approach, as the preliminary storing entities are charged as caching-entities in the Nearline-Storage of the above example.

4.3 SMAP_FS

SmApper has to make the attributes of the instantiated smap_base_type object persistent and carry out the procedure as efficiently as possible. Stacking allows us to execute this transparently on a base_type object in the course of every permitted access and thus to trace every modification in an atomic manner. The physical representation of the persistent smap_base_type object is, in principle, independent of that of the base_type object. This means that, theoretically, every physical management system (existing file systems, databases, etc.) could be considered for storage purposes.

The reasons why SmApper prefers a file system to a database are as follows:
The Stacking-Layer must be located in the kernel of the selected Appliance-Operating-System. Access to the selected storage management system should take place within the kernel for performance reasons (so that the data buffer does not have to be copied back and forth between user-space and kernel-space) which means that the management system has to be implemented on the kernel side. This would seem to favor choosing a file system as they are generally implemented on the kernel side whereas database management systems tend to run in user-space.
Attributes may be constructed hierarchically (see Section 3.1). Hierarchies in databases may be mapped by relations, however, performance suffers on moving lower down the hierarchy when SQL normal forms are adhered to. In the same way, the complexity of maintenance of the database schema increases cumulatively.
SMAP_FS provides a mechanism (QZone) which allows the buffering of files (caching), dispatching them to their target destination only on a well-defined point in time. As files would have to be treated as B(LOB) in a database, performance would once again suffer.
Nevertheless, we would like to point out that while it is technically feasible to draw on a database system as a storage management system, it does not seem to be 5 advantageous to do so at this point in time; however, this aspect may change in the future. One example of an interesting implementation of a file system ‘on top’ of a database is Michael A. Olson's approach which tackles features like querying and transaction security implicitly but which seems unsuitable for SmApper with these benchmarks [12,15].

The reasons why SmApper implements its own file system (SMAP_FS) are as follows:
The file system offered by SmApper must be optimized for so-called Lookups. This means that any search for a smap_base_type or a specific attribute of a smap_base_type as the case may be, must be extremely high-performance. Standard file systems often have to find a compromise specifically for lookups between the optimized locating of metadata entries(inodes) and quick access to actual blocks of data. On the other hand, the SMAP_FS stores the attribute values in the inode itself which leads to much higher performance but also means that only a pre-determined maximum size or length of attribute values can be saved. SMAP_FS is based on the assumption that, in accordance with the Pareto Analysis, at least 80% of the attribute values will fall within these pre-determined size limits. In all other cases, the value within the SMAP_FS-Inode refers to the actual data stream of the original file, which permits a retrieval of the attribute information but no (SMAP_FS-intrinsic) indexing.
SMAP_FS must permit smap_base_type objects to be identified via an explicit path as well as by query using appropriate attributes. Standard file systems do not implement query interfaces even though exceptions like BeFS, the BeOS file system, would seem to prove the rule [17].
The file system must ensure that the integrity of a smap_base_type is protected at all times (see in addition the system lemma of Section 3.3).
The file system must offer triggers, both conditional triggers (rule-based triggers) as well as unconditional.
The file system receives additional logic which allows it to apply extractors and converters to data streams while these are being written, which should lead to optimal performance.

The complete design and the implementation description of the SMAP_FS lie well beyond the scope of this description. At this point, it will be sufficient to establish that SMAP_FS is an optimized file system which will:
render smap_fs_type objects persistently available
protect the integrity of persistent smap_fs_type objects
ensure the permanent connection between base_type object and smap_base_type object
allow access to the attributes of the smap_fs_type object (directly and indirectly by query)
offer a mechanism which buffers the binary representation of the base_type object and later dispatch it to its static or dynamic target destination
offer versioning possibilities at file and block-level.

4.4 Access to smap_base_types

One of the most important basic requirements of a SmApper system is access to the extended attributes of the smap_base_type (see Section 3.3 entitled ‘SmApper—Basic Functions). As the SmApper systems have to be capable of being integrated smoothly into existing infrastructures, access to attributes must occur without any kind of proprietary protocol and must be based exclusively on standards.

SmApper solves this in a unique fashion by combining two standards:
Access via POSIX Standard (by path)
Access via XQuery/XPath (by query)

Access to a base_type occurs via path commands and via the usual POSIX-API (open, read, llseek etc.). Extended attributes of the smap_base_type are treated like individual files and are therefore also accessible via a (specific) path command as well as via POSIX-API. The following example will serve to illustrate this: the title of the original file (an MS Word document)/home/users/gth/hello.doc was extracted and saved in the attribute title in the SMAP_FS. Access to this attribute now occurs via the path command/home/users/gth/hello.doc?//title.

The delimiter serves only as an example here and can be configured. The path command is specific in our example and therefore delivers a SMAP_FS-file handle when an open-request is demanded. Finally, of course, the usual I/O operations can be carried out using this file handle. Should the attribute allow write-access then a write-syscall will only be successful when the modifications are also reflected in the original document (in our example/home/users/gth/hello.doc)—during an outbound-operation the write-request will be executed without modification to the original document. Should the modification to the original document, which will, of course, not take place until a later date, then fail, the file would be labeled with the corresponding status in the QZone.

Should the path command not lead to a specific SMAP_FS attribute (suppose, in our example, there were several titles) the path command would be treated as an access to a directory, in that the individual actual attributes could be treated by means of iterative access.

The query capacities of the SmApper namespace can be illustrated in the following examples; however, they act in the same manner as in the above example (which is, in effect, nothing more than a very simple query):
hello.doc?//title[position( )!=1]:
this delivers all the title attributes of the hello document except the first
hello.doc?//contains(title[position( )=1],confidential):
this delivers a file handle back to the hello document, should the word ‘confidential’ appear in the first title
hello.doc?//title[position( )=1]/subtitle:
this delivers the subtitle of the first title attribute of the hello document

The combination of the two standards (POSIX, XQUERY) enables the SmApper systems to be integrated smoothly into existing infrastructures, as the normal file access has not changed in any way. Access to the extended information of the SMAP_FS also takes place using the standard file I/O, the sole change being the extended path syntax that users, and in particular, applications must use when attribute access is required. As this extended syntax conforms to the accepted standards, its integration should not prove to be a huge investment for application developers.

4.5 Rules and Actions

Rules and actions form SmApper's actual compute-layer, allowing decisions to be made and actions to be taken on the basis of the extended information included in a smap_base_type as opposed to a base_type. Rules offer the possibility of forming Boolean Expressions using Boolean Operators (AND, OR, NOT) and datatype-specific operators (for example, =, !=, <, >, contains, etc.).

On the one hand, the attributes of smap_base_type can be considered operands, or even, on the other hand, constants like Literals, time commands like now, today, among others. Rules constitute SmApper's very simple model of the decision-making body. An example for a rule is:
(this_file.summary contains “ABC”) AND
this_file.uid=1001 )∥
(this_file.size <2048)

A rule always has access to all smap_base_type objects which are located within its scope. There are three ways of bringing an object into the scope:

1. Implicit: during a file system event, the object this_file is always located implicitly in the scope. This is the file which led to the trigger event of the rule.

2. By path: a new object can be instantiated in the scope by a definite SMAP_FS-Path, for example/smap_mnt/x.doc?uid

3. By query: objects can be instantiated by query (see Section 4.4 entitled Access to smap_base_types).

In SmApper, rules constitute the authority which decides whether an Action should be executed or not, and, if so, whether Action A or Action B should be executed. An Action can be any event from sending an email, the encrypting of data, the moving/copying of files within the storage networks, to access to a SAP system. SmApper even considers the extractors and converters previously introduced as actions in the broadest sense.

Owing to the diversity of potential actions, one of SmApper's basic requirements is that it must allow external, third-party applications to be accepted as actions. In the same way, SmApper's second and third basic requirements, follow on: it must ensure that the third-party application can in no way compromise the operation of the SmApper appliance. Furthermore, it must be capable of high-performance execution of actions.

These basic requirements are implemented in one of the core areas of SmApper's own operating system, the SmAp-OS, which is based on FreeBSD. While standard operating systems offer the concept of processes and threads as lightweight processes, actions exist in SmAp-OS as a third process abstraction layer, which can be thought of as ultra-lightweight-processes. This action authority operates in a type of Virtual Machine (VM) within the core of the SmAp-OS. This VM enables additional security parameters to be determined, for example:

1. max_time: Maximum duration of the action's execution in the system

2. max_call_depth: How many fork( )/exec( )-calls are permitted?

3. max_file_desc: How many file descriptors are permitted?

4. mem_areas_allowed: Access to which memory segments are permitted (DMA etc.)?

5. max_heap, max_stack: How large may individual memory segments be?

6. networking: Which network protocols are permitted?

7. pre-emptable: Can the action be interrupted?

However, the VM does not simply enable the performance of the actions to be determined, in order to achieve a higher level of security. The VM also provides a separate protected address room, which severs standard processes (system programs, etc.) and the kernel from actions. Should an action crash, then, in a worst case scenario, it would only affect itself and other actions but not the rest or the core of the SmApper system. Moreover, the separate address room provides the capacity for more efficient Context-Switching and for quicker process creation (no more memory areas, which have to be copied, etc.) As the SmAp-OS now recognizes the concept of action processes in addition to standard processes and real-time processes, a more granulating scheduling is possible, again leading to higher (or better adapted) performance.

In SmApper, rules and actions can be combined in a very simple but unique way, by using the concept of conditional cloning. With UNIX operating systems programs are carried out in two stages: firstly, by calling up one of the fork( ) system calls (vfork( ), clone( ) and so on) followed by one of the exec-system calls. Forking creates a copy of the program which is currently running in memory while the exec-call loads a new program in the memory which can be carried out. UNIX derivatives, in particular BSD and Linux, have implemented extremely efficient ways to start a program(=process creation) and yet this step still remains one of the most expensive services offered by an operating system. SmApper's conditional cloning allows the kernel to evaluate a rule before calling up the fork( )-syscalls and, depending on the result, to execute the forking plus all the ensuing steps or not.

In order to allow this connection, SmApper has the capacity to load pre-compiled rules into the kernel, where they can be connected with actions via Mapping Tables. This allows, for instance, an application to be started at any time but only when the rule has been complied with will it be carried out—without even causing serious additional cost to the system. A second means of establishing this connection is by calling up the SmApper-specific fork_if( )-syscall (instead of the fork( )-syscalls) which contains the rule-context as a standard parameter.

To summarize, SmApper permits the working or connection of rules and actions at the following junctures:

1. Rule/Action framework: A daemon in the user space which is available as a listener for events and pairs rules and actions up. Events may be file system events or timerbased events.

2. Conditional cloning: Carried out in the kernel, it allows a rule-preprocessing before the forking and may either be executed by successful action to rule mapping after a standard-fork( ) or by a dedicated call of a fork_if( )-syscall.

5. Applications

5.1 Features

The following is a list of technical features which a SmApper appliance itself provides partly by means of system implementation (as shown in Section 4) and partly by means of additional applications (actions, rules, etc). This list is not necessarily complete but will indicate some of the possibilities available when using SmApper.

Versioning: Versioning allows the user to create automatic versions of a file. Essentially, SmApper offers three methods of versioning: complete (each file is a completely new file including its meta data), modifications (only the modified blocks are saved) and meta data (there is only a physical data file which always corresponds to the last information; however the SMAP_FS retains the attribute information of older versions as read-only).

Semantic file access: This refers to the query-feature in SMAP_FS. The user is no longer only capable of accessing his files by path but also by queries to the attributes of the smap_base_type objects.

Context sensitive security: All the attributes of a smap_base_type object may have different security levels. This means that, for example, a user can see the title of a certain document but may not read the contents.

Hidden files/parts of files: Depending on context-sensitive security, it is also possible to make files, parts of files or even whole directory trees invisible to certain users or user groups. This would give executives, for instance, much higher security levels when storing sensitive information.

Implicit copies: SMAP_FS enables n copies of a file to be created and maintained easily, even in different destinations or file systems.

Conversions: n converters can be defined per scope. This means, for instance, that an incoming TIFF file can be converted automatically into a JPEG, or a thumbnail and a low-resolution preview can be created. When all these new, converted files are added to the original smap_base_type using attach’, SmApper automatically reflects every modification to the original file in the converted extracts. Further examples of automatic converters include compression algorithms (ZIP etc.) and encryption algorithms.

Alerts/Notifications: The (rule-based) triggering function in SMAP_FS allows every user and/or program to be notified automatically by alarm, message, text-message, email and so on regarding any form of file access. This may be relevant for security reasons but may also be an advantage as a workflow feature or serve to relieve the system administrators.

Statistics: SmApper allows almost unlimited statistics to be recorded via File I/O. Using this tool, it would not only be conceivable to measure when and how often a particular file was opened or modified but also which parts of it were affected. Moreover, it would be possible to keep track of accessing clients in order, for instance, to acknowledge a storage location which does not correspond to user patterns and therefore seems disadvantageous. Also analysis could be made which would permit an evaluation of data to be performed under the heading ‘What does it contribute to the net product of the company?’.

Replication: Following on from implicit copies, replication means that SmApper enables rule-based replications to be carried out at file as well as block level. A useful replication would mean for example that a file is replicated automatically in a storage location which is more in keeping with user patterns, in order to increase performance (see Statistics).

Distributed data: As the SMAP_FS cancels the direct connection between logical file access and physical file location permanently using the stacking layers, files or parts of files can move within a storage grid in a rule-based way. In other words, this capability merges the caching and storage components which, until now, had been treated separately.

Virtual directories: Using SMAP_FS, files which are physically located in completely separate tree structures or even different file systems can be logically displayed as though they are in one directory. To give a practical example, these could be directories for project groups or virtual company teams.

Content integrity: SMAP_FS safeguards the integrity of all attributes of a smap_base_type object, from system-specific attributes to user-defined attributes. This allows a file to be given additional information, whose life cycle is equally linked to the file as its contents.

Several file views: Using the capacity to extract and convert data and then add it as an attribute (or an attribute object) to the original file, it is possible to allow several ways of viewing a file. For instance, a user could preview a CAD document without having installed the CAD application. Newspaper headline editors would be able to view the headline only of a story without having to struggle with the rest of it and even to modify it without needing the full editorial system. As a further variation, there could be a network-specific or even device-specific view of a file. A PDA for example could get a lower resolution than a conventional PC.

Combining of file parts: It is no problem at all to combine several fragments of different files and combine them to create a new file with SMAP_FS. For example, it would be very simple to write all the titles of Word documents in a new document.

Audit trail: Using the versioning feature, it is possible to show who modified what and when, at the binary data level as well as at attribute level.

Conditioned ACLs: SMAP_FS allows not only rigid user/groups entitlements to be assigned but also rule-based access rights. One example of this is that a particular file may only be read and modified by User Y on Day X. Only after 10 p.m. are all users permitted to read the document. An embargo function for product launches or for news items, which are subject to a time blackout, for instance, would be feasible using this feature.

Implementation of digital workflows: This means that SmApper allows different stations in a file's life cycle to become capable of being automated. News wire pictures, for example, which are sent to a publisher, could be processed automatically and directed to the appropriate photo editors; when they are finished, the pictures could be automatically transferred to the repro directory and so on.

Shared task automation: Shared tasks include the printer, fax, tape drives, CD writers, archives, microfilm areas, etc. The sending of data to these devices can be managed under rule-based conditions which is equivalent to an intelligent, adaptable spooler.

Multilingual feature: Documents or parts of documents can be translated automatically and, using the “Several views per file” feature, can even be opened in the appropriate language, based, for instance, on the Client-IP address.

Scheduled tasks: Scheduled tasks allow all the above-mentioned features to be carried out at any pre-defined point in time and not only “On demand,” that is, when File I/O has taken place.

Storage virtualization: SmApper is an implicit storage virtualizer, meaning that n storage devices can be concealed behind it. However, these devices can be perceived in a different form, as m devices, by the user. Storage devices can be combined in a rule-based fashion or may be connected statically.

5.2 Modules

The following section introduces the core modules, which SmApper offers in the form of feature packages. Feature packages mean an interaction of features as presented in the previous section. However, each module contains additional tools and topics, which are only implemented within the context of the module (e.g. configuration clients, administrative clients, etc.). The individual modules are as follows:
Information Lifecycle Management (ILM)
Security
Data management
Workflow

Information Lifecycle Management (ILM)

The purpose of the module Information Lifecycle Management (ILM) is to enable several physical storage systems (file servers, local drives, (i)SANs) to be combined into logical units and to be presented to the user as such, namely as “new” storage resources. Moreover, it should facilitate a decision based on rules regarding the location at which each file is to be stored. Furthermore, it will allow the system to review even in retrospect whether file X, which was stored at time y in location z, should still be stored there at a pre-defined point in time or whether fundamental parameters have been modified, demanding a new decision. This module hereby allows the user to employ his storage infrastructure in the most efficient and economical manner.

The factors which are of influence to this decision process are the following:
disk utilization
proximity to user (latency)
share access speed/user (stats)
costs per MB
storage technology
security level (depending on whether the drives are mirrored or not, etc.)

In order to be able to describe terms like costs per MB, security level, etc., reasonably clearly, SmApper introduces its own Device-Description-Language which allows infrastructure elements managed or addressed by SmApper (hard drives, printers, facsimile machines, CD writers, file servers, etc.) to be defined, this definition to be deposited in SMAP_FS where it is re-used as an object for ILM decisions. An interesting approach, which deserves to be examined in greater detail at this juncture, is presented in the technical paper entitled “File Classification in Self-Storage-Systems” [15]. This approach assumes that the storage infrastructure components are self-administering, self-configuring and self-tuning, and are capable of not only describing and recording statistically the behavior patterns in the utilization of the data stored on them but also of predicting them. This approach would lead to documents being automatically classifiable, which would bring supplementary facilitation in ELM concepts.

Security:

In its standard form, SmApper only skirts the subject of security (that is, without the security module) and only then in as much as the security mechanisms of the fundamental storage infrastructures are used, their results being binding for SmApper. The security module provides SmApper with a more thorough, more finely granulated data security mechanism. On the one hand, this means that in this case SmApper has to understand external security mechanisms (particularly Active Directories and NIS/NIS+). On the other hand, most of the features discussed in the previous section (context sensitive security, hidden files/parts of files, alerts, conversions, etc.) allow a range of combinations of additional security features, which is difficult to be achieved in this degree of automation without SmApper.

Data management:

Under the heading of data management, we consider the following topics:
conversions
versioning
multilingual feature
several views of a file

The goal of data management is to simplify to a large extent the actual management of unstructured data via automation using the aforementioned feature packages.

Workflow:

The purpose of the module ‘Workflow’ is to describe the digital lifecycle of a file, the relevant conditions, events and rules and automate it as well as possible. This module is specifically designed to replace so-called “Polling Daemons” (which track directories according to input and then take certain actions) but it is also designed to replace existing spooling systems (for printers, file servers, burning processes, etc.). A further use for this module is to permit a connection to a groupware environment.

6. Conclusion

6.1 Related Topics

When it is a question of research and possible methods of resolution “Management of unstructured data using structured meta data” is a very broad field. This section attempts to demonstrate the basic direction of the various approaches to the topic which are generically related in subject matter to SmApper while, at the same time, offering a brief demarcation to SmApper.

The first method of approach is based for the most part on the concept of the so-called Semantic File Systems written by Gifford et al. [11]. In the same way as SmApper, the Semantic File System allows data to be extracted via freely defined programs by means of so-called transducers, then to be saved as Key Value Pairs and finally to be recalled using the query concept of the virtual directories. Gifford's approach enables an indexed meta data structure to be set up parallel to the original file system. The primary differences between the Semantic File System as opposed to SmApper are as follows:
it is implemented as a NFS file system, meaning that no heterogeneous landscapes are possible (as opposed to the VFS SmApper approach)
it is implemented as software, meaning that maintenance and support appear to be more complex when compared to the SmApper appliance approach
Semantic File Systems only permit intrinsic attributes and therefore no additional, freely defined attributes unlike SmApper
attributes are always read-only
no actions, no rules
no specialized file system making meta data persistently high-performance
no meta data hierarchies
only strings and integers are permitted as meta data types
the software runs in userspace resulting in lack of performance in high-performance enterprise applications.

Based on Gifford et al., the so-called hierarchy and content approach [13] shows the extension of the Semantic File Systems concept in the sense that query results no longer provide virtual directories but actual physical directories which can then be modified by the user; although this allows for a high degree of flexibility it also involves different challenges as a result of inconsistency. This latter approach differs to the same extent from SmApper as Gifford et al. does.

Sedar [14] presents a further, interesting alternative in the form of a new file system as a storage location for meta data and data by introducing the concept of semantic vectors. The aim here is to optimize the storage requirement of similar blocks/files using semantic hashing. This approach appears to be very interesting for future reference even though, at the time of publication, it seemed to have a long way to go before the implementation is realizable. The same is true of Gifford et al. as opposed to SmApper.

A further related concept to the SmApper paradigm is that of the semantic web. [8, 9] The background of the semantic web concept is best explained in the following quotation from the article “The Semantic Web” in the Scientific American: “ . . . The Semantic Web is an extension of the current web in which information is given well-defined meaning, better enabling computers and people to work in cooperation . . . .” [8]. The Semantic Web is based on the Resource Description Framework (RDF), which integrates a variety of applications, in particular XML. The authors analyze the advantages and disadvantages of using XML or XML/RDF as a description of the smap_base_type attributes but this has no fundamental bearing on the whole concept. Thus the Semantic Web approach is not a rival concept but could instead be viewed as synergetic to SmApper (see also [16]).

One highly interesting approach which could also lead to an improvement in data management is the Storage Grid approach followed by Network Appliance [10]. Storage Grid will be able to aggregate physical storage devices in a logical way, packaging them accordingly in front of the user—the whole procedure independent of protocols, technology and even physical locations. This concept could even make classical storage virtualization solutions obsolete. At present, however, only one manufacturer seems capable of realizing this concept, namely Network Appliance, and even then it is merely a concept which will be realizable solely by using the equipment of that one manufacturer, though this could of course change in time. From the SmApper viewpoint, Storage Grid is an additive concept as storage virtualization is not merely one of the core features of SmApper but in fact imperative for SmApper to be able to implement its features. On the contrary, SmApper allows to unleash the real power of a grid.

There is a multitude of (particularly commercial but also open source) applications, which reproduce parts of SmApper's functionality. Of particular note are Content-Management-Systems, Groupware-Systems, ILM-Systems as well as extended storage concepts. To date, however, the inventors are not aware of any concept that is capable of combining the advantages outlined in Section 6.2 entitled ‘What makes SmApper unique?’

6.2 What Makes SmApper Unique?

The uniqueness or innovation of SmApper can be considered from two sides:

1. From an abstract solution oriented point of view

2. From a technical point of view

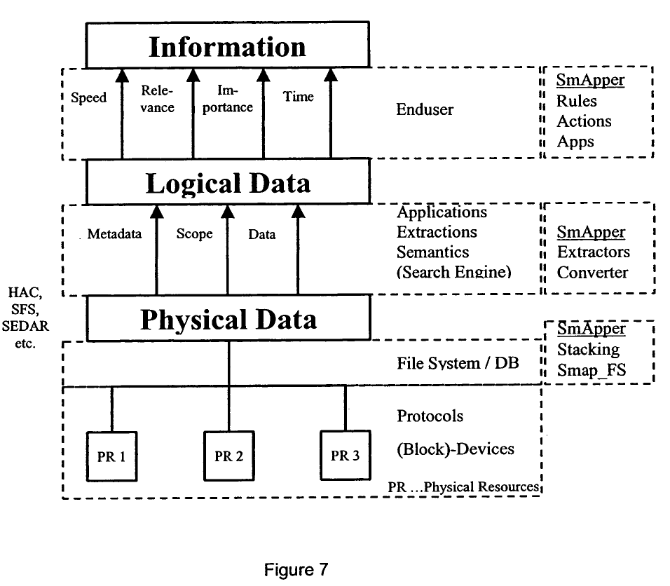

When it is a question of solution orientation, FIG. 7 will help to demonstrate the innovative nature of the concept. According to this Figure SmApper bypasses all layers from the physical representation to information as the only meta data solution. In contrast to all the other comparable state-of-the-art solutions we have looked at, SmApper does not simply focus on one of the two lower layers (physical data/logical data) but also helps to bridge the gap between logical data and information as such. SmApper achieves this by systemically integrating its new data types (smap_base_types) by means of rules and actions that although syntactically and semantically defined, can be freely selected. This is the missing factor, which we fail to find at all in any of the approaches discussed here.

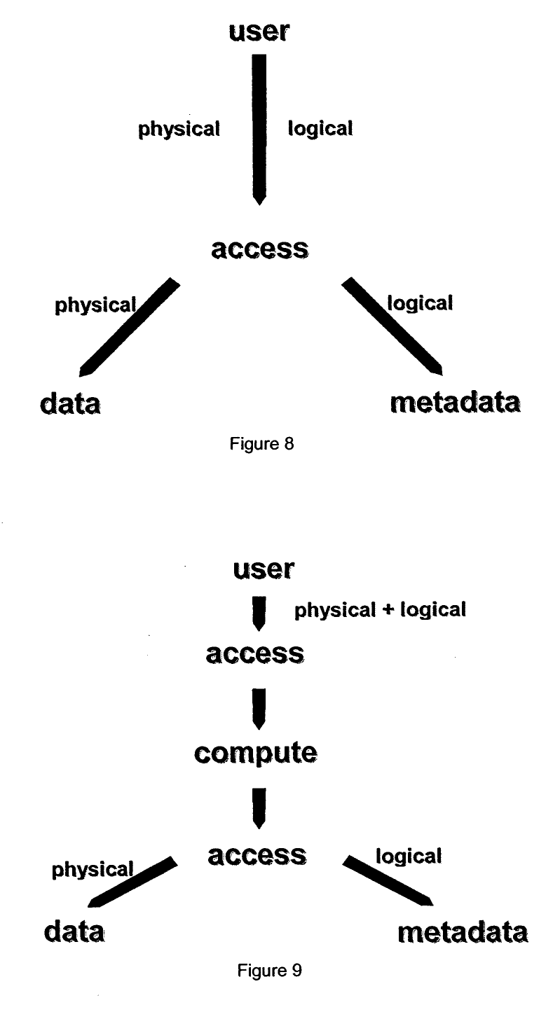

Or, in other words, FIGS. 8 and 9 help to grasp the paradigm shift made possible using SmApper. While, at present, physical access to files (I want file X) and logical access (I want all files which are important at this point in time and which I have not yet read) run separately from one another, logical access even having to be translated into physical access first of all by a compute-layer (=application), SmApper's namespace concept by_path/by_query enables physical and logical access to be executed simultaneously in a single standard-compliant file-descriptor. Moreover, SmApper integrates the compute-layer into the access transaction by means of rules and actions in such a way that it runs during access, or inbound, which is also innovative.

Technologically speaking, it is primarily the symbiosis of existing or similar models and their refinement, extension and supplementation. Conceptually, SmApper can be defined as a modified, enhanced semantic-file-system approach, which has been extended by object-oriented data type integrity, access methodology and persistence on the basis of stacking, whereby the atomically guaranteed correlation between data and meta data appears innovative. In addition, SmApper lays down a rule and action model in order to be able to carry out decisions and actions with these datatypes in a well-defined framework. It is also a completely new idea to integrate these technological approaches in their entirety in a Blackbox-Principle (appliance) in order to guarantee the end user maximum simplicity and the ability to retain the existing infrastructure.

In addition, contingent on its goal of managing enterprise data, SmApper is streamlined for performance by its design and its implementation. Every relevant, I/O-specific part is carried out in the kernel of the selected operating system. Even parsing in the SMAP_FS can be executed in the kernel.

FIG. 9: SmApper combines logical and physical data access and allows inbound computing during the access process.

6.3 Challenges

The primary challenges in the further development of SmApper can be divided into two groups:

1. Appliance

2. Software development

Appliance:

The invention can be implemented in hardware or software or both. When the topic of appliance is involved, even the choice of adequate hardware is a challenge in itself. The designing, carrying out and testing alone of test and benchmark scenarios in order to identify key performance criteria, whether for small or large-scale enterprise operations, is highly complex. The hardware should be modulated according to these results. At the moment, SmApper is developing its prototypes on an INTEL SR2300, a 2U-OEM-Server with a E7501-Motherboard, two Xeon processors and 2 GB of memory. Further tests are required to determine whether a concept based on serverblades would be more adaptive to scaling performance levels in the long-term.

Software development:

The greatest challenges within the framework of actual software development are:
time
complexity of the kernel modules
transaction security: what is the meaning of ‘atomic’ in the scope of SmApper and how is this safeguarded?
development of parsers (specifically in badly documented formats, e.g. MS Word formats higher than Word97)
complexity in the development of a file system in general
performance and stability of SMAP_FS
distributed SmApper appliances
actions and rules: how is the stability of the whole system safeguarded when carrying out the User-Code?

The illustration of FIG. 9 represents graphically SmApper's fundamental features once again as a tool to monitor and control unstructured or semi-structured digital packs of data.

In the context of the description of an implementation example according to the present invention the square brackets refer to the following references:

[1] School of Information Management and Systems at the University of California at Berkeley, How much Information? 2000, http://www.sims.berkeley.edu/research/projects/how-much-info/index.html, (2000).

[2] S. R. Kleiman, Vnodes: An Architecture for Multiple File System Types in Sun UNIX. USENIX Conf. Proc., pages 238-47, Summer 1986.

[3] Erez Zadok, Jason Nieh, FiST: A Language for Stackable File Systems, USENIX Technical Conference, June 2000.

[4] Erez Zadok, Ion Badulescu, Alex Shender, Extending File Systems Using Stackable Templates, USENIX Technical Conference, June 1999.

[5] Erez Zadok, Ion Badulescu, A Stackable File System Interface For Linux, LinuxExpo 99, May 1999.

[6] Wolfgang Mauerer, Linux Kernelarchitektur Konzepte, Strukturen und Algorithmen von Kernel 2.6, Carl Hanser Verlag, Muinchen, Wien, 2004.

[7] Robert Love, Linux Kernel Development A practical guide to the design and implementation of the Linux kernel, Sams Publishing, Indianapolis, 2004.

[8] Tim Berners-Lee, James Hendler, Ora Lassila, The Semantic Web, Scientific American, May 2001.

[9] W3C Semantic Web, http://www.w3.org/2001/sw/.

[10] Network Appliance, Inc., Storage Grid Architecture, http://www.netapp.com/news/press/2003/20031104.ppt, Slides 10-12, 2003.

[11] David K. Gifford, Pierre Jouvelot, Mark A. Sheldon, James W. O'Toole, Jr., Semantic File Systems ACM Symposium on Operating Systems Principles archive, Proceedings of the thirteenth ACM symposium on Operating systems principles table of contents, Pacific Grove, California, United States, Seiten 16-25, 1991.

[12] Michael A. Olson, The Design and Implementation of the Inversion File System, USENIX Technical Conference, January 1993.

[13] Burra Gopal, Udi Manber, Integrating Content based Access Mechanisms with Hierarchical File Systems USENIX Technical Conference, February 1999.

[14] Mallik Mahalingam, Chunqiang Tang, Zhichen Xu, Towards a Semantic, Deep Archival File System USENIX conference on File and Storage Technologies, 2002, Monterey, Calif., USA.

[15] Michael Mesnier, Eno Thereska, Gregory R. Ganger, Daniel Ellard, Margo Seltzer, File classification in self-* storage systems, First International Conference on Autonomic Computing, NY, Mai 2004.

[16] Sabin-Corneliu Buraga, An XML-based Semantic Description of Distributed File Systems, RoEduNet International Conference, Iasi, Juni 2003.

[17] Dominic Giampaolo, Practical File System Design with the Be File System, Morgan Kaufmann Publishers Inc., (1999).

What is claimed is:

1. A process in a data processing system of managing unstructured or semi-structured digital data in a file system supported by a computer, wherein when data is accessed, logical access and physical access are executed jointly, the process comprising a particularly transparent, common access mechanism that is implemented for both logical access and physical access.

2. A process according to claim 1, wherein within the execution of the access mechanism a file path is processed which has been enhanced by a Query-Interface.

3. A process according to claim 2, wherein the Query-Interface used in an extended file path comprises an enhancement of a POSIX- or similar standard in the form of an XQuery-Standard or similar standard.

4. A process according to claim 1, wherein arbitrarily pre-definable data subsets are extracted when accessing unstructured and/or proprietary structured data.

5. A process according to claim 4, wherein the extracted data subsets are stored as meta data in a structured form.

6. A process according to claim 5, wherein intrinsic and/or extrinsic data subsets are used to form the respective meta data.

7. A process according to claim 5, wherein the meta data is created from arbitrarily pre-definable data subsets when unstructured and/or proprietary structured data is read and/or written or stored.

8. A process according to claim 1, wherein the process is carried out while preserving the atomicity of the sum of all partial transactions regarding all data which is linked to respective source data and/or files.

9. A process according to claim 1, wherein well-defined decisions and/or actions are carried out based on the results of a processing under a pre-defined and customizable rule and action model.

10. A process according to claim 1, wherein data is subject to a pre-defined and customizable rule and action model.

11. A process according to claim 10, wherein part-programs or actions of the rule and action model are carried out in a kernel of an operating system, with the execution being bound to rules and conditions.

12. A process according to claim 11, wherein the part-programs or actions are executed automatically.

13. A process according to claim 1, wherein the process is carried out in an individual unit by using standardized software and hardware interfaces, without interference in or modification to an existing structure.

14. A process according to claim 5, wherein the meta data is set up in its own file system on the basis of the common access mechanism which is optimized for the quick lookup of data contents and/or attributes of data contents.

15. An appliance for processing unstructured, digital data in a data processing installation supported by a computer wherein the appliance is designed to implement a process in which when data is accessed, logical access and physical access are executed jointly, comprising a particularly transparent, common access mechanism that is implemented for both logical access and physical access by assigning resources to connect the appliance to the standardized software and hardware interfaces of the data processing installation or a system network.

16. An appliance according to claim 15, wherein the appliance is integrated as a closed unit into a data processing installation without interference in or modification to an existing structure of the same data processing installation.

17. An appliance according to claim 15, wherein the appliance includes resources to encompass all levels of the unstructured data, from its physical representation through logical classification to its information content, the information content being edited and adjusted to fall within a well-defined framework of actions and/or decisions.

18. A computer program product wherein, once imported into a main or working memory of a data processing installation, the product causes the execution of a process in which when data is accessed, logical access and physical access are executed jointly, comprising a particularly transparent, common access mechanism that is implemented for both logical access and physical access.
